(19) United States
(12) Patent Application Publication
(10) Pub. No.: US 2013/0180491 A1
(43) Pub. Date: Jul. 18, 2013

(54) IGNITION DEVICE HAVING AN IMPROVED THERMAL BEHAVIOR

(71) Applicant: Lothar Detels, Burgberg (DE)

(72) Inventor: Lothar Detels, Burgberg (DE)

(21) Appl. No.: 13/817,620

(22) PCT Filed: Jul. 20, 2011
(86) PCT No.: PCT/EP2011/062440

§ 371 Date: Apr. 1, 2013

(30) Foreign Application Priority Data
Aug. 20, 2010 (DE) 102010039587.0

(51) Int. Cl. F02N 11/00

(52) U.S. Cl. CPC F02N 11/00
USPC 123/179.28

(57) ABSTRACT

An ignition device for an internal combustion engine includes: a voltage generator having a coil, an electronic module, and a housing having a housing wall, the housing wall having a first planar wall area and a second planar wall area and a connecting area connecting the first and the second planar wall areas, a cooling area being provided between the first planar wall area and the second planar wall area, which cooling area is connected to an external surrounding area and provides cooling of the first and second planar wall areas, and the planar wall areas dividing the housing into a first space, in which the coil is situated, and a second space, in which the electronic module is situated.

### BACKGROUND OF THE INVENTION

1. Field of the Invention

The present invention relates to an ignition device for an internal combustion engine, which has an improved thermal behavior and consequently in particular a longer service life.

2. Description of the Related Art

Ignition devices for internal combustion engines are known from the related art in various embodiments. The tendency of motor vehicle manufacturers to reduce the engine sizes as well as the engine spaces also affects all components of the engine such as ignition devices, for example. The ignition devices normally comprise a transformer area, including an ignition coil and an iron core, as well as an electronic module. To reduce the dimensions, the electronic module would have to be situated relatively near to the transformer area. This could increase the heat input from the transformer area into the electronic module, however, which may result in a reduced service life of the electronic module due to the increased temperature. A reliability of the ignition devices would thereby be reduced.

### BRIEF SUMMARY OF THE INVENTION

By contrast, the ignition device according to the present invention has the advantage that a heat load on the electronic module from a transformer area as voltage generator is as low as possible and that it nevertheless has a compact construction. For this purpose, the present invention in particular eliminates a direct heat conduction between the transformer area and the electronic module such that a thermal load on the electronic module occurs only as a result of heat radiation, which results in a lower heat transfer in comparison to a heat conduction. The present invention for this purpose provides a housing having a housing wall, the housing wall having a first planar wall area and a second planar wall area. The two planar wall areas are connected to each other via a connecting area in such a way that a cooling space exists between the first and the second planar wall areas. The cooling space is connected to the surroundings and thus acts as a thermal barrier between the transformer area and the electronic module. The two planar wall areas divide the housing into an accommodating space for the transformer area and an accommodating space for the electronic module. Since the cooling space between the planar wall areas is connected to the surroundings, an improved heat dissipation from the cooling space is made possible. In terms of thermal technology, the present invention thus makes it possible to decouple the electronic module from the transformer area.

Particularly preferably, the first planar wall area is parallel to the second planar wall area. This makes it possible to ensure in particular vertical contact surfaces on the inner sides of the planar wall areas.

In a particularly preferred manner, the cooling space for this purpose has a width that is greater than respectively a thickness of the first and the second planar wall areas. This ensures that the cooling space has a certain minimum width in order to allow for sufficient cooling of the wall areas such that a heat conduction via the wall areas, which can result in the transfer of heat from the transformer area to the electronic module, is as low as possible. A sum of the thickness of the first planar wall area and the thickness of the second planar wall area is preferably smaller than the width of the cooling space. This ensures effective cooling.

Furthermore, the electronic module is preferably disposed at a distance from the first planar wall area. This prevents a direct contact between the electronic module and the planar wall area such that here too heat may be transferred at most via heat radiation. Since the planar wall areas are connected to the cooling space, however, the heat transfer effected thereby is relatively low.

According to another preferred embodiment of the present invention, the cooling space is developed as a slot-like space, which runs in the radial direction of the ignition coil. This results in relatively long paths, via which heat may be conducted via the first and the second planar wall areas into the vicinity of the electronic module such that the heat arriving there is already at a relatively low temperature level.

The slot-like cooling space is preferably disposed in the radial direction of the ignition coil in such a way that it extends over a center axis of the ignition coil.

Furthermore, the cooling space is preferably developed on the housing wall in such a way that it has three open sides. This allows for an air flow through the cooling space, which ensures particularly effective heat dissipation.

The cooling space according to the present invention may thus be integrated easily into the housing wall when manufacturing the housing, e.g., using an injection molding process. This results in no increase in manufacturing costs, with the exception that a bit more material must be applied for the two planar wall areas. This is of no consequence, however. According to the present invention, the molding of the housing wall is thus used to provide a cooling space that prevents the electronic module of the ignition device from being subjected to an excessive thermal load. The present invention thus offers a particularly simple solution for a further miniaturization of the ignition device.

### BRIEF DESCRIPTION OF THE DRAWINGS

FIG. 1 shows a schematic sectional view of an ignition device according to one exemplary embodiment of the present invention.

FIG. 2 shows an enlarged schematic sectional view of the ignition device of FIG. 1.

### DETAILED DESCRIPTION OF THE INVENTION

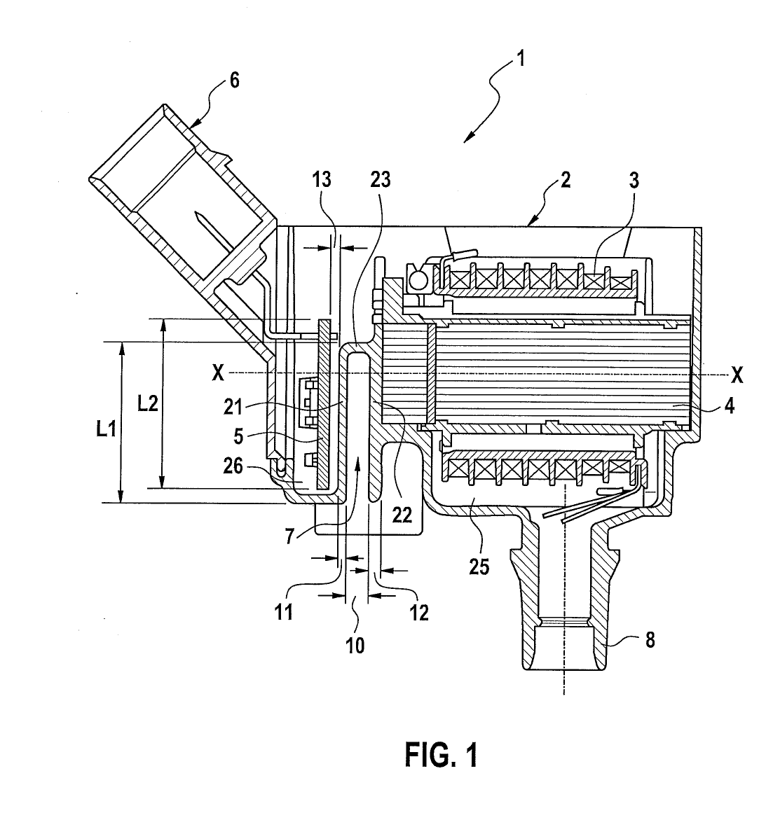

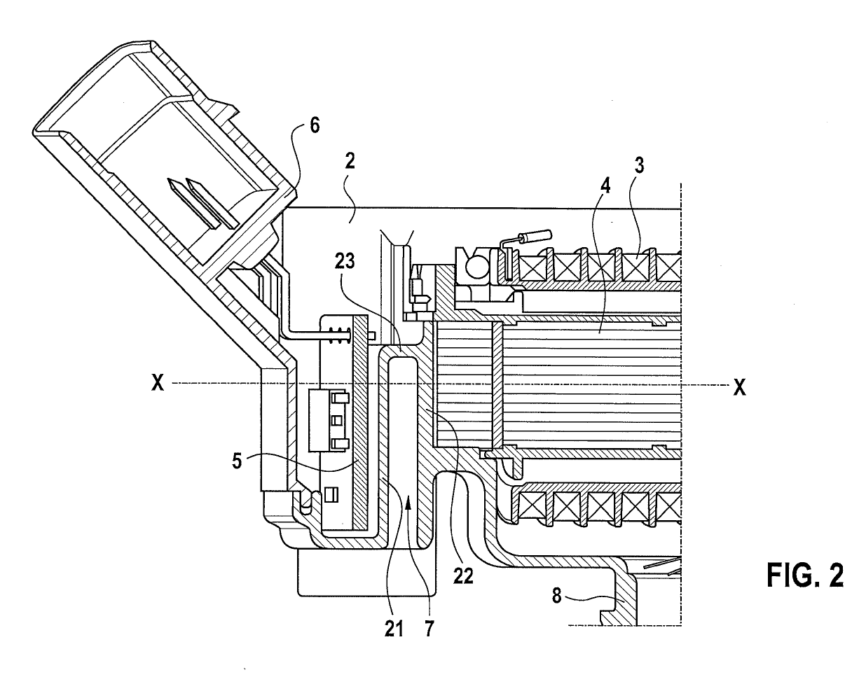

An ignition device 1 according to an exemplary embodiment of the present invention is described in detail below with reference to FIGS. 1 and 2. The ignition device 1 according to the present invention comprises a housing 2, in which a coil 3 and a core 4 made of iron in the form of a multitude of lamina are disposed. Furthermore, a plug 6 is provided for electrical contact and a connection 8 to the spark plug is developed on housing 2.

Ignition device 1 furthermore comprises an electronic module 5, which is for example a circuit board having appropriately equipped components. Electronic module 5 is connected both to plug 6 as well as to coil 3.

Housing 2 is manufactured from a plastic material and is produced by injection molding for example. As shown in FIGS. 1 and 2, housing 2 is developed having a relatively thin housing wall, the housing wall comprising a first planar wall area 21 and a second planar wall area 22. The two planar wall areas 21 and 22 are disposed in parallel to each other and are connected to each other via a connecting area 23. As may be seen from FIGS. 1 and 2, a slot-shaped cooling space 7 is developed between first planar wall area 21 and second planar wall area 22. Cooling space 7 is connected to the ambient air and is used to cool wall areas 21 and 22.

Furthermore, the arrangement of the two planar wall areas 21 and 22 divides housing 2 into a first space 25, in which coil 3 and core 4 are situated, and a second space 26, in which electronic module 5 is situated.

As may be seen especially from FIG. 1, plate-shaped electronic module 5 is likewise situated in parallel to first planar wall area 21. In this instance, electronic module 5 is disposed at a certain distance 13 on first planar wall area 21. As may also be seen from FIG. 1, cooling space 7 has a width 10. Furthermore, a thickness of first planar wall area 21 is indicated in FIG. 1 by reference numeral 11, and a thickness of second planar wall area 22 is indicated by reference numeral 12. As shown in FIG. 1, thickness 11 in this instance is less than thickness 12. Furthermore, width 10 of cooling space 7 is wider than respectively the thickness 11 of first planar wall area 21 and the thickness 12 of second planar wall area 22 and also wider than their sum. This ensures effective cooling.

As shown especially in FIG. 1, cooling space 7 extends in the radial direction of coil 3, beginning from an outer side of housing 2 to beyond a center axis X-X of coil 3. This ensures that cooling space 7 penetrates deep into the housing interior and that a sufficient thermal isolation is possible between first space 25 and second space 26. In this instance, a depth of slot-like cooling space 7 corresponds to a length L1 of first planar wall area 21, minus a thickness of connecting area 23 (cf. FIG. 1). Moreover, a length L2 of the electronic module equals the length L1.

Since most of the heat is generated in first space 25, in which coil 3 is situated, the arrangement of first and second planar wall areas 21, 22, oriented from an outer side of the housing inward, allows for a thermal separation between the first and the second space of housing 2. Cooling space 7 in this instance is preferably open both towards the bottom as well as towards at least one side so as to provide for the best possible air flow through cooling space 7. It is particularly preferred for cooling space 7 to be open towards three sides. Cooling space 7 furthermore prevents a direct conduction of heat to electronic module 5 since only a small and thin connecting area 23 is provided between second planar wall area 22 and first planar wall area 21. Heat may be transferred via cooling space 7 only by thermal radiation, which results in a significantly poorer thermal coupling.

Thus, according to the present invention, a lower base temperature may be obtained for electronic module 5 by thermal decoupling using cooling space 7 such that a service life of electronic module 5 may be increased significantly. According to the present invention, cooling space 7 may be produced in a simple manner during the manufacture of housing 2. Since this practically does not raise the manufacturing costs for the housing, the present invention is able to provide a cost-free cooling body by cooling space 7. Hence, even for one skilled in the art, the present invention surprisingly solves the heat problem on the electronic module since with ever greater reduction of the dimensions of internal combustion engines, the electronic modules must be disposed ever more closely to the coils of the ignition device. Distance 13 between electronic module 5 and first planar wall area 21 additionally furthers the reduction of the base temperature of electronic module 5 since here too heat is able to be transferred to electronic module 5 solely by radiation. The present invention is thus able to provide a clearly improved ignition device without a complicated construction or increased manufacturing costs.

1-9. (canceled)

10. An ignition device for an internal combustion engine, comprising:
a voltage generator having a coil;
an electronic module; and
a housing having a housing wall, wherein the housing wall has a first planar wall area, a second planar wall area, and a connecting area connecting the first and the second planar wall areas, and wherein a cooling space is provided between the first planar wall area and the second planar wall area, the cooling space being connected to an external surrounding area and providing cooling of the first and second planar wall areas, and wherein the first and second planar wall areas divide the housing into a first space in which the coil is situated and a second space in which the electronic module is situated.

11. The ignition device as recited in claim 10, wherein the first planar wall area is parallel to the second planar wall area.

12. The ignition device as recited in claim 11, wherein the cooling space has a width which is greater than a thickness of the first planar wall area and greater than a thickness of the second planar wall area.

13. The ignition device as recited in claim 12,
wherein a sum of the thicknesses of the first and second planar wall areas is smaller than the width of the cooling space.

14. The ignition device as recited in claim 12,
wherein the electronic module is situated at a distance from at least the first planar wall area.

15. The ignition device as recited in claim 12, wherein the cooling space is a slot-like space which extends in a radial direction of the coil.

16. The ignition device as recited in claim 15, wherein the cooling space extends in the radial direction of the coil via a center axis of the coil.

17. The ignition device as recited in claim 12,
wherein the cooling space has three open sides and the connecting area forms a base side.

18. The ignition device as recited in claim 12,
wherein a length of the first planar wall area corresponds approximately to a length of the electronic module.
